(19) United States
(12) Patent Application Publication
(10) Pub. No.: US 2019/0054532 A1
(43) Pub. Date: Feb. 21, 2019

(54) SYSTEMS AND METHODS FOR BRIDGING COMPONENTS

(71) Applicant: DIVERGENT TECHNOLOGIES, INC., Los Angeles, CA (US)

(72) Inventors: Jon Paul Gunner, Palos Verdes Estates, CA (US); John Russell Bucknell, El Segundo, CA (US); Broc William TenHouten, Rancho Palos Verdes, CA (US); Eahab Nagi El Naga, Topanga, CA (US); William Bradley Balzer, Santa Monica, CA (US); Antonio Bernerd Martinez, El Segundo, CA (US)

(21) Appl. No.: 15/682,385

(22) Filed: Aug. 21, 2017

(51) Int. Cl. B22F 3/105; B33Y 10/00; B33Y 30/00; B23K 11/10

(52) U.S. Cl. CPC B22F 3/1055; B23K 11/105; B33Y 30/00; B33Y 10/00

(57) ABSTRACT

One aspect is an apparatus including a node having a socket configured to receive a component and a detachable additively manufactured nozzle co-printed with the node and arranged for adhesive injection between the component and the socket. Another aspect is an additively manufactured apparatus including a first additively manufactured component having an area configured to receive a second additively manufactured component. The first component includes an adhesive channel for injecting adhesive into the area when the second component is being connected to the first component. Another aspect is an apparatus including a plurality of additively manufactured components each having an adhesive injection channel. The components are connected together such that adhesive injection channels are aligned to form an adhesive path that allows adhesive flow between the components.

### BACKGROUND

### Field

The present disclosure relates generally to apparatus and techniques in manufacturing, and more specifically to bridging of three-dimensional (3-D) printed components for use in producing vehicles, boats, aircraft and other mechanical structures.

### Background

Three-dimensional (3-D) printing, which may also be referred to as additive manufacturing, is a process used to create 3-D objects. The 3-D objects may be formed using layers of material based on digital model data of the object. A 3-D printer may form the structure defined by the digital model data by printing the structure one layer at a time. 3-D printed objects may be almost any shape or geometry.

A 3-D printer may disseminate a powder layer (e.g., powdered metal) on an operating surface. The 3-D printer may then bond particular areas of the powder layer into a layer of the object, e.g., by using a laser to bond the powder of the powder layer together. The steps may be repeated to sequentially form each layer. Accordingly, the 3-D printed object may be built layer by layer to form the 3-D object.

3-D printed components may be used to produce sub-components for various devices or apparatus. The 3-D printed sub-components may need to be attached or connected to other sub-components, including other 3-D printed sub-components, extruded sub-components, or still other sub-components. For example, one 3-D printed component may be used to bridge two or more other components together. The two or more other components may or may not be 3-D printed components.

### SUMMARY

Several aspects of apparatus for bridging will be described more fully hereinafter with reference to three-dimensional printing techniques.

One aspect is an apparatus including a node having a socket configured to receive a component and a detachable additively manufactured nozzle co-printed with the node and arranged for adhesive injection between the component and the socket.

Another aspect is an additively manufactured apparatus including a first additively manufactured component having an area configured to receive a second additively manufactured component. The first component includes an adhesive channel for injecting adhesive into the area when the second component is being connected to the first component.

Another aspect is an apparatus including a plurality of additively manufactured components each having an adhesive injection channel. The components are connected together such that adhesive injection channels are aligned to form an adhesive path that allows adhesive flow between the components.

Another aspect is a vehicle including a plurality of subassemblies, each of the subassemblies having a plurality of additively manufactured components each having an adhesive injection channel. The components for each of the subassemblies are connected together such that adhesive injection channels are aligned to form an adhesive path that allows adhesive flow between the components. Each of the subassemblies may be connected together such the adhesive path for each of the subassemblies are aligned to allow the adhesive to flow between the subassemblies.

It will be understood that other aspects of apparatus for bridging will become readily apparent to those skilled in the art from the following detailed description, wherein it is shown and described only several embodiments by way of illustration. As will be realized by those skilled in the art, the apparatus for bridging are capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatus for bridging will now be presented in the detailed description by way of example, and not by way of limitation, in the accompanying drawings, wherein:

FIGS. 1A-D illustrate respective side views of an exemplary 3-D printer system;

FIG. 2 illustrates an example of an apparatus that may be used for sheet metal to node connections;

FIG. 3 illustrates another example of an apparatus that may be used for sheet metal to node connections;

FIG. 4 illustrates another example of an apparatus that may be used for sheet metal to node connections;

FIG. 5 illustrates another example of an apparatus that may be used for sheet metal to node connections;

FIG. 6 further illustrates the example apparatus of FIG. 5 assembled;

FIG. 7 illustrates another example of an apparatus that may be used for sheet metal to node connections;

FIG. 8 illustrates another example of an apparatus that may be used for sheet metal to node connections;

FIG. 9 further illustrates the example apparatus of FIG. 8; and

FIG. 10 is a flowchart illustrating an example method in accordance with the systems and methods described herein.

### DETAILED DESCRIPTION

The detailed description set forth below in connection with the appended drawings is intended to provide a description of various exemplary embodiments of apparatus for bridging with 3-D printed components and is not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the invention to those skilled in the art. However, the invention may be practiced without these specific details. In some instances, well-known structures and components may be shown in block diagram form, or omitted entirely, in order to avoid obscuring the various concepts presented throughout this disclosure.

The use of 3-D printing may provide significant flexibility for enabling manufacturers of mechanical structures and mechanized assemblies to manufacture parts with complex geometries. For example, 3-D printing techniques provide manufacturers with the flexibility to design and build parts having intricate internal lattice structures and/or profiles that may not be possible to manufacture via traditional manufacturing processes or may be cost prohibitive to manufacture via traditional manufacturing processes. As discussed above, the 3-D printed sub-components may need to be attached or connected to other sub-components, including other 3-D printed sub-components, extruded sub-components, or still other sub-components. Accordingly, one 3-D printed sub-component, extruded sub-component, or other sub-component may be used as a bridge to two or more other components. The bridge may be used to connect the two or more other components together. In an aspect, one or more of the other components may be 3-D printed sub-components, extruded sub-components, or still other sub-components.

In an aspect, one or more of the bridge components described herein and the two or more other components described herein may be dissimilar materials. Connections between dissimilar materials may lead to galvanic corrosion between the dissimilar materials. Accordingly, some aspects may include components that may block or decrease galvanic corrosion between the dissimilar materials. For example, some aspects may include one or more spacers, seals, inserts, gaskets, washers, linings, liners, or other blocking material between dissimilar materials. The one or more spacers, seals, inserts, gaskets, washers, linings, liners, or other blocking material may be configured such that the dissimilar materials do not come in contact with each other. Having spacers, seals, inserts, gaskets, washers, linings, liners, or other blocking material may prevent galvanic corrosion from occurring. Spacers, seals, inserts, gaskets, washers, linings, liners, or other blocking material may generally be applied to each example described herein, particularly examples that may include components of dissimilar materials.

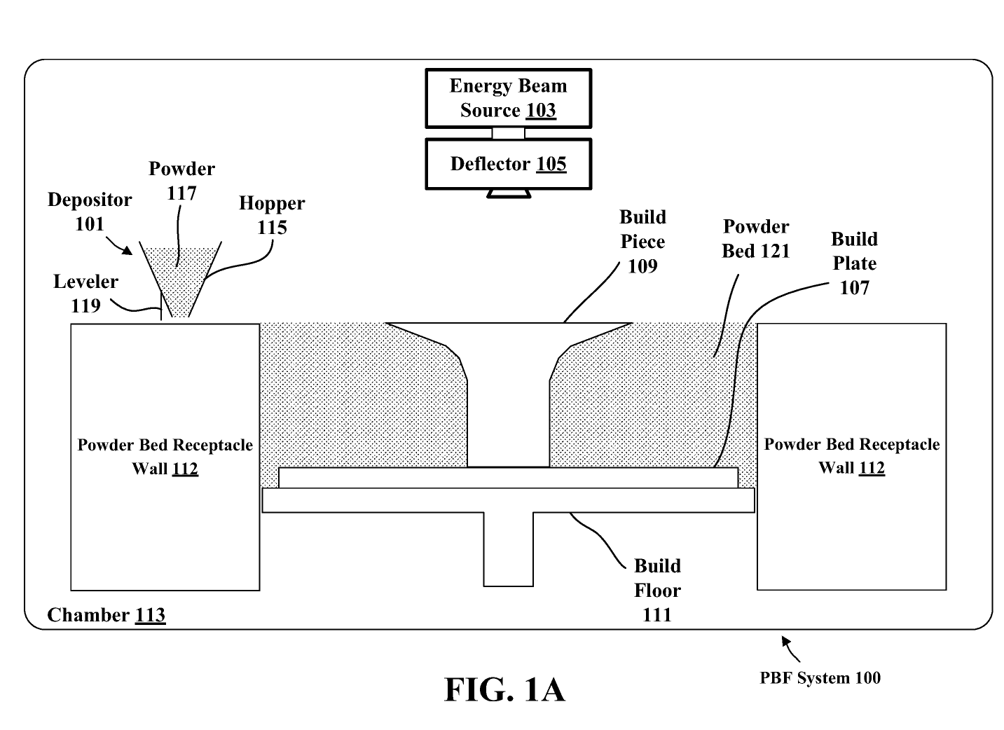

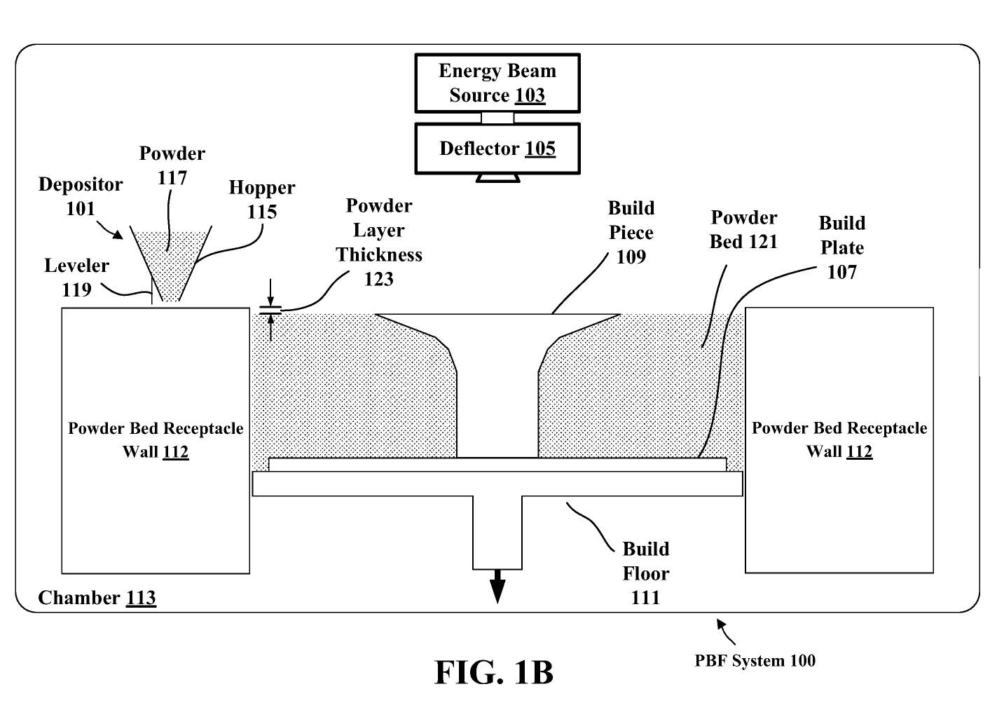

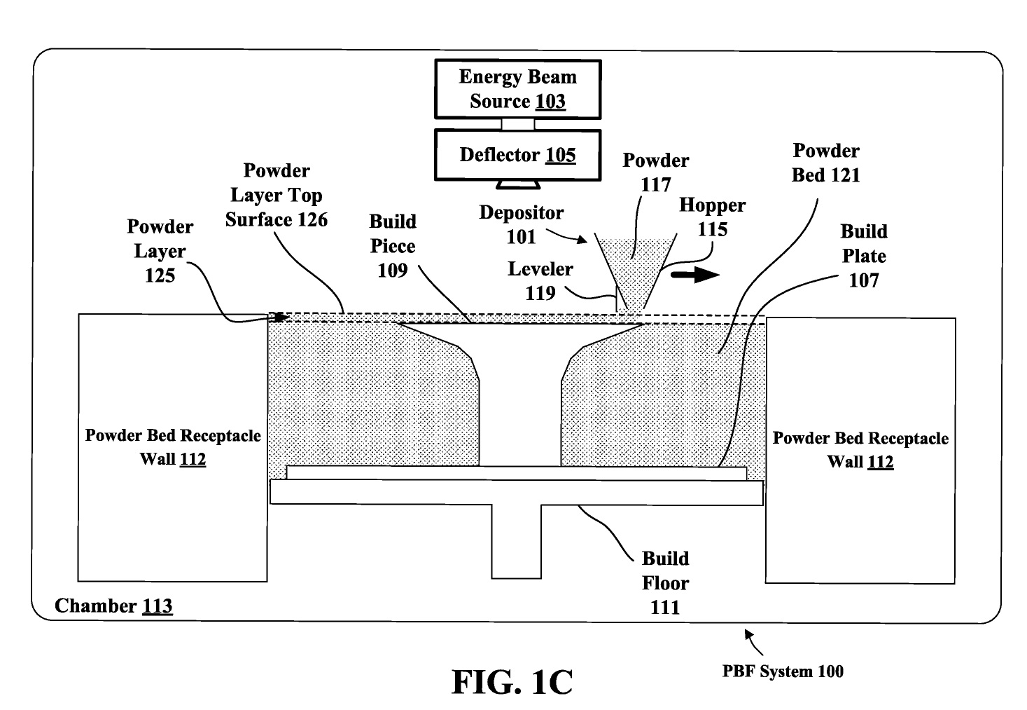

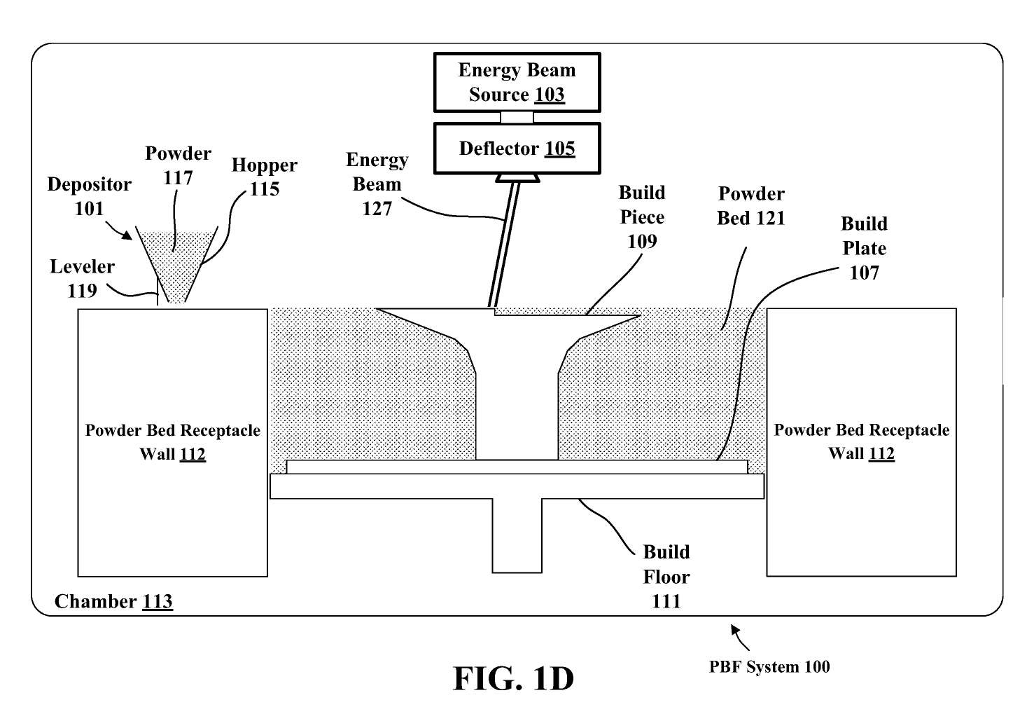

FIGS. 1A-D illustrate respective side views of an exemplary 3-D printer system. In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously-deposited layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

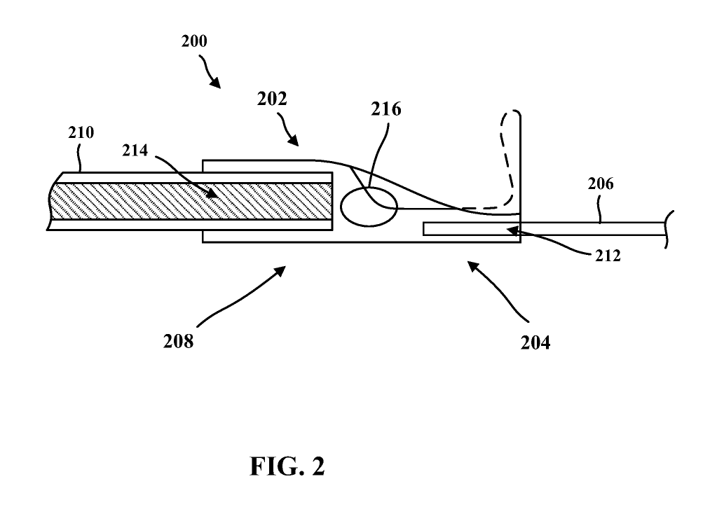

FIG. 2 illustrates an example of an apparatus 200 that may be used for sheet metal to node connections. For example, the apparatus 200 may include a node 202, such as a 3-D printed sub-components, extruded sub-components, or still other sub-component. The node 202 may include a first portion 204 configured to support a metal sheet 206 and a second portion 208 configured to support a component 210. Accordingly, the node 202 may be used to couple the metal sheet 206 to the component 210. In an aspect, the first portion 204 of the node 202 may include a first socket 212 and the second portion 208 of the node 202 may include a second socket 214. Accordingly, the metal sheet 206 may be inserted into the socket 212 and the component 210 may be inserted into the socket 214. The socket 212 may secure the metal sheet 206 to the node 202. The socket 214 may secure the component 210 to the node 202.

In one aspect, the component 210 may be a shear plate. The shear plate may be inserted into the socket 214 on one side of the node 202. In an aspect, the node 202 may be an extrusion-like node 202. In other words, the node 202 may be the same or similar to a node that is extruded. For example, the node 202 may have a uniform cross section. In some aspects, the node 202, may be additively manufactured, rather than extruded.

In an aspect, the socket 212 may be a thinner socket, e.g., relative to the socket 214. The socket 212 may be on the other side of a node 202 from the socket 214. The socket 212 may attach to another, thinner panel, such as a metal sheet 206. In an aspect, the first socket may be located at one end of the node and the second socket may be located at an opposite end of the node. In an aspect, the node 202 may be elongated between the one end of the node and the opposite end of the node.

In an aspect, the metal sheet 206 may be supported by the first portion 204 of the node 202 and the component 210 may be supported by the second portion 208 of the node 202. In an aspect, the component 210 may be a metal component. In an aspect, the component 210 may be an additively manufactured component. In an aspect, the component 210 may be a panel. In an aspect, the node 202 may further include mass reduction feature such as an opening 216 located between the first socket 212 and the second socket 214. In an aspect, the node 202 may include a first section including the first portion 204 and a second section including the second portion 208. The first section may be interconnected with the second section.

In an aspect, the apparatus 200 may further include at least one of a spacer, a seal, an insert, a gasket, a washer, a lining, a liner, or a sealant between at least one of the first portion 204 and the metal sheet 206 or the second portion 208 and the component 210. The spacer, seal, insert, gasket, washer, lining, liner, or sealant may reduce galvanic corrosion by forming a gap between the at least one of the first portion and the metal sheet or the second portion and the component.

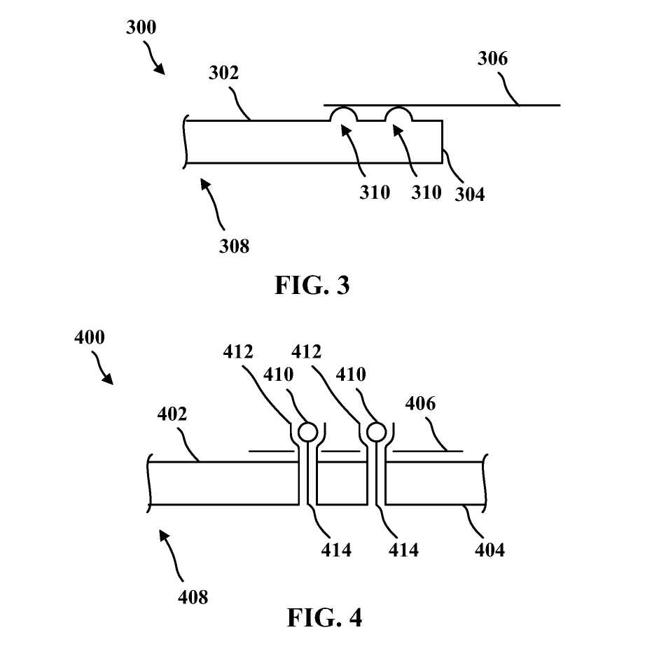

FIG. 3 illustrates another example of an apparatus 300 that may be used for sheet metal to node connections. The apparatus may include an additively manufactured node 302. The additively manufactured node 302 may include a first portion 304 and a second portion 308. The first portion 304 may be configured to support or attach to a metal sheet 306. The second portion 308 may be configured to support a component (not shown). Accordingly, the node 302 may thereby couple the metal sheet 306 to the component that is not shown. For example, the second portion 308 may be configured to support a component (not shown) using the systems and methods described herein.

The node 302 may be made from steel or some other metal or combination of metals, e.g., an alloy. The metals or alloys used to make the node 302 may be metals or alloys of metals capable of being welded. In some examples, the node 302 may generally be the same or similar metal to the metal sheet 306. More particularly, the node 302 may generally be a metal that is capable of being welded to the metal of the metal sheet 306. In some examples, the node 302 and the metal sheet 306 may be different metals. The node 302 and the metal sheet 306 may generally be made from of metals or alloys that are compatible for welding. In other aspects, components may be fastened using one or more of welding, mechanical fastening, or adhesion.

As illustrated in FIG. 3, the node 302 may be printed or additively manufactured with specific spot weld protrusions 310. The spot weld protrusions 310 may allow the node 302 to be attached to sheet metal, e.g., by welding. The term “allowed” is not intended to indicate that the welding could not occur without the protrusions 310. Rather, the spot weld protrusions 310 may improve the quality of a weld between the node 302 and the metal sheet 306, make the welds easier to perform, or in some other way improve the weldability of the metal sheet 306 and the node 302. Generally, the spot weld protrusions 310 may be a same metal or alloy as the node 302. The spot weld protrusions 310 may be a metal or alloy that is capable of being welded to the metal of the metal sheet 306. When welded, the metal protrusions 310 may melt into the metal of the metal sheet 306.

As illustrated in FIG. 3, the first portion of the node may include a first weld protrusion 310 and a second weld protrusion 310. In an aspect, the metal sheet 306 may be welded to the node 302 at the first and second weld protrusions 310. In other aspects, components may be fastened using one or more of welding, mechanical fastening, or adhesion.

FIG. 4 illustrates another example of an apparatus 400 that may be used for sheet metal to node connections. The apparatus 400 may include an additively manufactured node 402. The additively manufactured node 402 may have a first portion 404 configured to support a metal sheet 406 and a second portion 408 configured to support a component (not shown). The node 402 may couple the metal sheet 406 to the component. The first portion 404 of the node 402 may include one or more additively manufactured fasteners 410. In an aspect, the additively manufactured fasteners 410 may be co-printed with the node 402. Accordingly, the additively manufactured fasteners 410 may be manufactured at the same or virtually the same time.

In an aspect, each of the one or more fasteners 410 may be a blind rivet (410). A blind rivet is a type of mechanical fastener that may be used to attach a first piece to a second piece. The first piece may be attached to the second piece using the blind rivet or multiple blind rivets. For each blind rivet, a first hole in the first piece and a second hole in the second piece may be aligned. The blind rivet may be introduced through the first hole and the through second hole. For example, the blind rivet may include a cylindrical barrel that may be passed through the aligned first and second holes. The blind rivet may also include a flange at a first end of said the cylindrical barrel for engaging the first piece to prevent further passage of said barrel through the aligned first and second holes. The blind rivet may also include a pin axially through the barrel having a head in external abutment with a second extremity of said barrel. The pin may be pulled through the barrel to engage with and deform the barrel

Blind rivets (410) may be printed into the node 402 so that the node 402 may be attached to the metal sheet 406. In an example, the co-printed blind rivets (410) may each include a barrel 412 that is part of the node 402. The blind rivets (410) may also each include a pin 414. The pin 414 may deform the barrel 412 to attach the metal sheet 406 to the node 402. In another aspect, the barrel may be co-printed as a separate part from the node 402, e.g., within a hole in the node 402.

Co-printing the node 402 to including additively manufactured fasteners (410), such as blind rivets, may allow for utilizing such fasteners (410) in locations in a node 402 that might not otherwise be accessible for such fasteners. For example, the example of FIG. 4 may allow blind rivets to be used in locations that might not be accessible to the blind rivets after the node 402 has been additively manufactured.

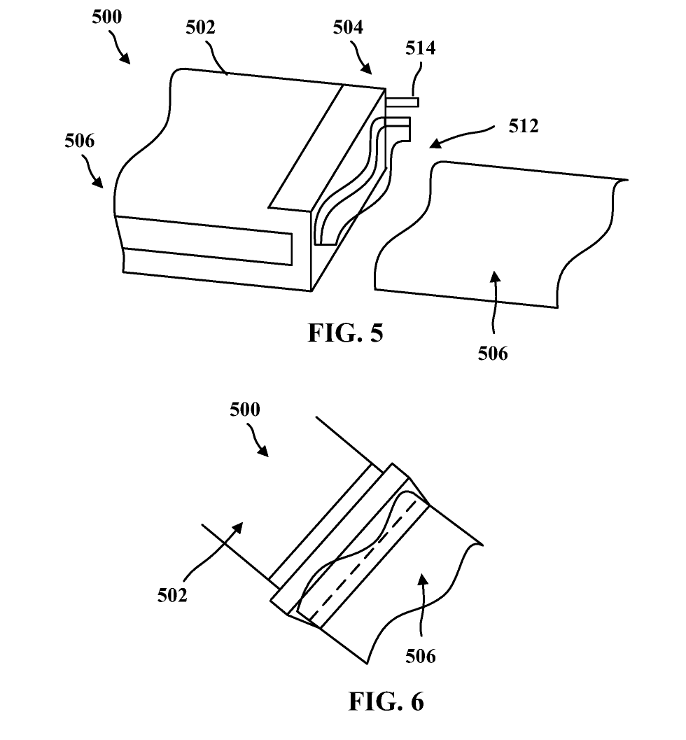

FIG. 5 illustrates another example of an apparatus 500 that may be used for sheet metal to node connections. The apparatus 500 may include an additively manufactured node 502 having a first portion 504 configured to support a metal sheet 506 and a second portion 508 configured to support a component (not shown). The apparatus 500 may couple the metal sheet 506 to the component (not shown).

In an aspect, the first portion 504 of the node 502 may include a slot 512. The slot 512 may have a corrugated surface and a flat surface. In an aspect, the corrugation may be additively manufactured. For example, the slot 512 may be additively manufactured with the corrugation created during the additive manufacturing. In another aspect, the corrugation may be introduced by mechanical deformation in a post-processing. For example, the slot 512 may be additively manufactured and the corrugation may be created after the additive manufacturing. The flat surface may be opposite the corrugated surface. In an aspect, the apparatus 500 may further include an adhesive injection channel 514 for injecting adhesive into the slot 512. An adapter piece with a corrugated bottom and flat top may be printed to adhere to the top of corrugated metal sheet 506. Glue ports for adhesive may be printed into the adapter.

FIG. 6 further illustrates the example apparatus 500 of FIG. 5 assembled. In the example of FIG. 6, the additively manufactured node 502 is coupled to the metal sheet 506. The metal sheet 506, e.g., with the adapter piece, is inserted in the slot 512 having the corrugated surface and the flat surface. Adhesive may be used to secure the additively manufactured node 502 and the metal sheet 506.

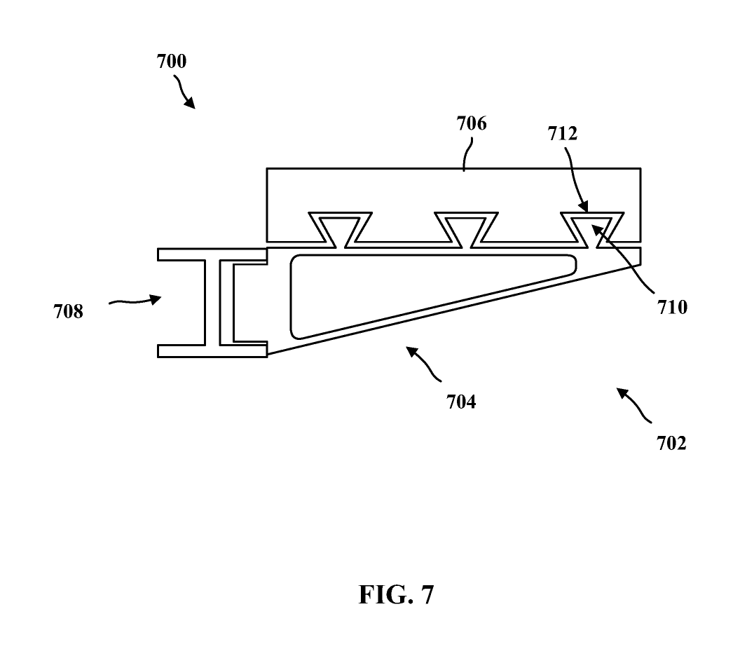

FIG. 7 illustrates another example of an apparatus 700 that may be used for sheet metal to node connections. The apparatus 700 may include an additively manufactured node 702 having a first portion 704 configured to support a metal sheet 706 and a second portion 708 configured to support a component to thereby couple (not shown) the metal sheet 706 to the component (not shown).

The node 702 may include a first section including the first portion 704 and a second section including the second portion 708. The first section may be interconnected with the second section. In an aspect, the first section, the second section, or both, may include a plurality of dovetail structures 710 and the other one of the first and second sections comprises a plurality of sockets 712 with each of the dovetail structures 710 located in a corresponding one of the sockets 712, e.g., when the metal sheet 706 and the node 702 are connected. In an aspect, the first section may be co-printed with the second section. In an aspect, the first section may be joined to the second section, e.g., by welding, such as when the node 702 and the metal sheet 706 are compatible metals for welding. In an aspect, the metal sheet 706 may be welded to the first portion 704 of the first section of the node 702.

For example, in an aspect, an aluminum node (702) may be inserted within a socket (712) in an aluminum extrusion and secured via welding. The aluminum node (702) may be attached to a steel node via multiple dovetail interconnects, e.g., without welding. In another aspect, the interface may either be welded, the two parts may be co-printed, or both. In an aspect, a steel node (702) may be welded to a piece of metal sheet (706), e.g., in addition to the dovetail interconnects. Alternatively, a combination of welds of compatible metals may be used with dovetail interconnects for weld incompatible metals to make any needed connections. In other aspects, components may be fastened using one or more of welding, mechanical fastening, or adhesion. Accordingly, needed connections may be made using one or more of welding, mechanical fastening, or adhesion.

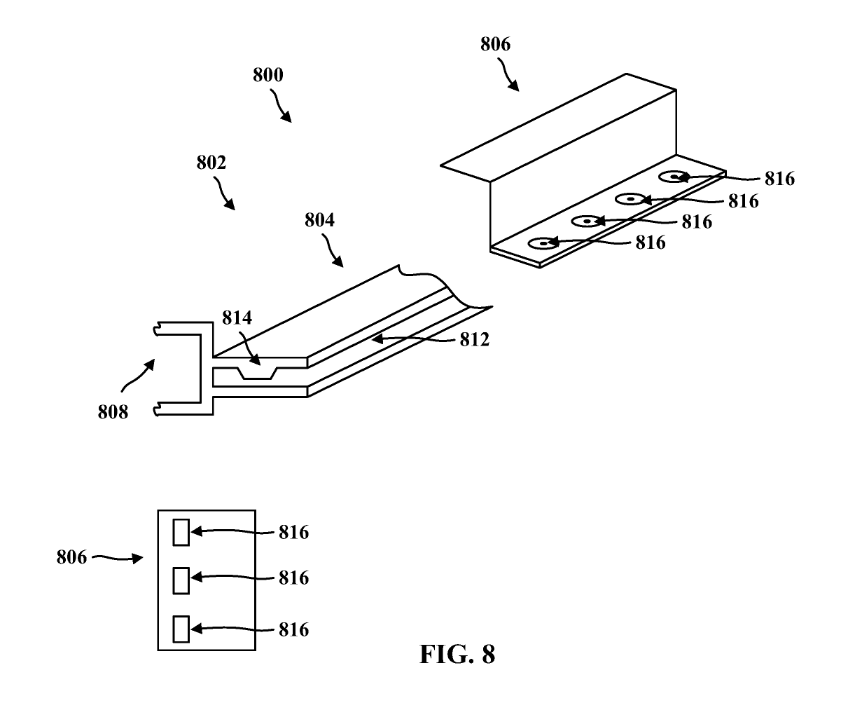

FIG. 8 illustrates another example of an apparatus 800 that may be used for sheet metal to node connections. The apparatus 800 may include an additively manufactured node 802 having a first portion 804 configured to support a metal sheet 806 and a second portion 808 configured to support a component (not shown). The node 802 may couple the metal sheet 806 to the component (not shown).

In an aspect, the node 802 may further include a socket 812 having a plurality of protrusions 814. In an aspect, the apparatus 800 may further include the metal sheet 806 located in the socket 812. The metal sheet 806 may have a plurality of holes 816. Each of the protrusions 814 may extend through a corresponding one of the holes 816. In an aspect, at least one of the protrusions 814 may be stitch welded to an internal surface of the socket 811. In other aspects, components may be fastened using one or more of welding, mechanical fastening, or adhesion.

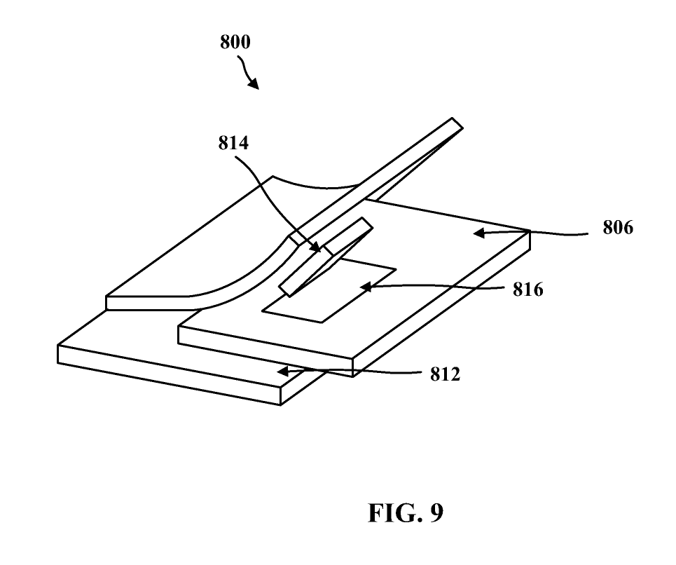

FIG. 9 illustrates a close up view of the metal sheet 806 including a hole 816 of the plurality of holes 816 and a protrusion 814 extending through the hole 816. In an aspect, at least one of the protrusions 814 may be stitch welded to an internal surface of the socket 812. In an aspect, the metal sheet 806 may be located in the socket 812. The metal sheet 806 may have a plurality of holes 816 with each of the protrusions 814 extending through a corresponding one of the holes 816.

In an aspect, machine holes 816 may be drilled into a panel of one metal type. The panel may be inserted into a socket 812 within a node (802) of another metal type. The socket may contain intermittent protrusions 814. The protrusions 814 may be stitch welded together.

In an aspect, assembling the components further may include tack welding the components together. In an aspect, adhering the components together further may include curing the adhesive in an oven. In an aspect, dipping said at least a portion of the vehicle into a substance to prepare said at least a portion of the vehicle for painting might include dipping said at least a portion of the vehicle into a colloidal particle suspension in an electric field. In other aspects, components may be fastened using one or more of welding, mechanical fastening, or adhesion.

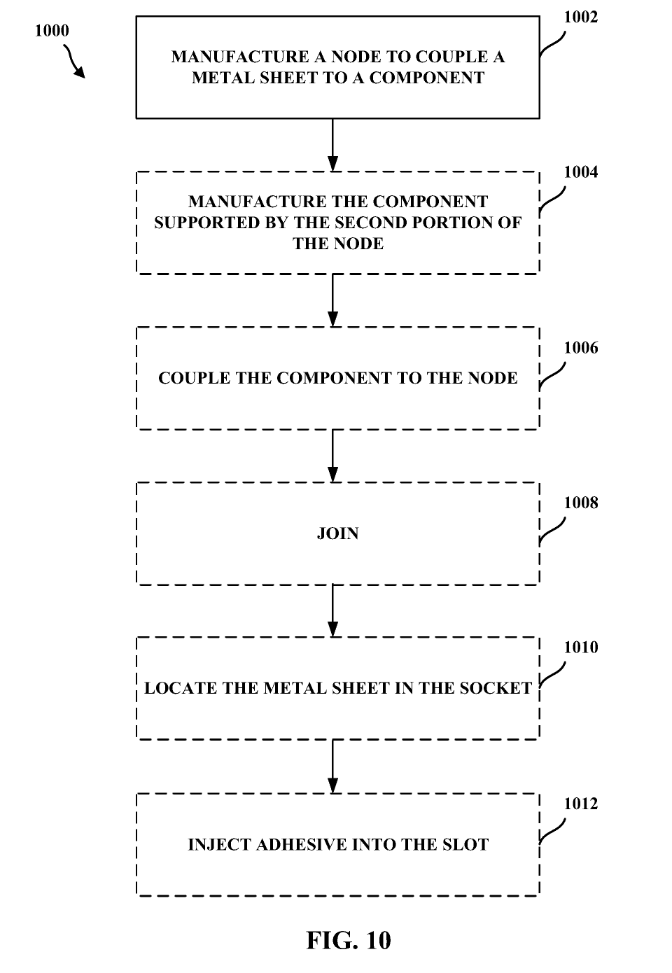

FIG. 10 is a flowchart 1000 illustrating an example method in accordance with the systems and methods described herein. At block 1002, manufacture, e.g., additively manufacture, a node having a first portion configured to support a metal sheet and a second portion configured to support a component to thereby couple the metal sheet to the component. For example, additively manufacture a node (202, 302, 402, 502, 702, 802) having a first portion (204, 304, 404, 504, 704, 804) configured to support a metal sheet (206, 306, 406, 506, 706, 806) and a second portion (208, 308, 408, 508, 708, 808) configured to support a component (e.g., 210) to thereby couple the metal sheet (206, 306, 406, 506, 706, 806) to the component (e.g., 210). In an aspect, additively manufacturing the first portion (204, 304, 404, 504, 704, 804) may include additively manufacturing a first socket (212) and additively manufacturing the second portion (208, 308, 408, 508, 708, 808) of the node (202, 302, 402, 502, 702, 802) includes additively manufacturing a second socket (214).

In an aspect, additively manufacturing the node (202, 302, 402, 502, 702, 802) includes additively manufacturing the first socket (212) located at one end of the node (202, 302, 402, 502, 702, 802) and the second socket (214) located at an opposite end of the node (202, 302, 402, 502, 702, 802). In an aspect, additively manufacturing the node (202, 302, 402, 502, 702, 802) includes additively manufacturing the node (202, 302, 402, 502, 702, 802) with an elongation between the one end of the node (202, 302, 402, 502, 702, 802) and the opposite end of the node (202, 302, 402, 502, 702, 802). In an aspect, additively manufacturing the node (202, 302, 402, 502, 702, 802) further includes additively manufacturing a mass reduction feature such as an opening (216) located between the first socket (212) and the second socket (214).

In an aspect, additively manufacturing the node (202, 302, 402, 502, 702, 802) includes additively manufacturing a first section including the first portion (204) and a second section including the second portion (208). The first section may be interconnected with the second section.

In an aspect, additively manufacturing one of the first and second sections includes additively manufacturing a plurality of dovetail structures (710) and wherein additively manufacturing the other one of the first and second sections includes additively manufacturing a plurality of sockets (712) with each of the dovetail structures (710) located in a corresponding one of the sockets (712).

In an aspect, additively manufacturing the first section and the second section includes co-printed the first section and the second section. In an aspect, additively manufacturing the node (302) further includes additively manufacturing the first portion (304) of the node (302) including a first weld protrusion (310) and a second weld protrusion (310).

In an aspect, additively manufacturing the node (402) further includes additively manufacturing the first portion (404) of the node (402) with one or more additively manufactured fasteners (410) co-printed with the node (402).

In an aspect, additively manufacturing the node (502) further includes additively manufacturing the first portion (504) of the node (502) with a slot (512) having a corrugated surface and a flat surface opposite the corrugated surface. In an aspect, additively manufacturing the node (802) includes additively manufacturing the node (802) with a socket (812) having a plurality of protrusions (814).

In an aspect, additively manufacturing the node (502) further includes adding or including at least one of a spacer, a seal, an insert, a gasket, a washer, a lining, a liner, or a sealant between at least one of the first portion 204 and the metal sheet 206 or the second portion 208 and the component 210. The spacer, seal, insert, gasket, washer, lining, liner, or sealant may reduce galvanic corrosion by forming a gap between the at least one of the first portion and the metal sheet or the second portion and the component.

At block 1004, manufacture the component supported by the second portion of the node. For example, manufacture the component supported by the second portion (208, 308, 408, 508, 708, 808) of the node (202, 302, 402, 502, 702, 802). In an aspect, the component may be a metal component. In an aspect, manufacturing the component may include additively manufacturing the component. In an aspect, the component may be a panel.

At block 1006, the component may be coupled to the node. For example, the component (210) may be coupled to the node (202).

At block 1008, the first section may be joined to the second section, e.g., by welding the metal sheet to the first portion (204, 304, 404, 504, 704, 804) of the first section of the node (202, 302, 402, 502, 702, 802), stitch weld at least one of the protrusions (814) to an internal surface of the socket (812), or weld the metal sheet to the node (302) at the first and second weld protrusions (310). In other aspects, components such as the first section and the second section may be fastened using one or more of welding, mechanical fastening, or adhesion.

At block 1010, locate the metal sheet in the socket, the metal having a plurality of holes with each of the protrusions extending through a corresponding one of the holes. For example, locate the metal sheet (806) in the socket (812), the metal sheet (806) having a plurality of holes (816) with each of the protrusions (814) extending through a corresponding one of the holes (816).

At block 1012, inject adhesive into the slot. For example, adhesive may be injected into the slot (512).

In an aspect, each of the one or more fasteners includes a blind rivet or other joining techniques such as pins, screws, adhesives, or other techniques used to join two or more components.

The previous description is provided to enable any person skilled in the art to practice the various aspects described herein. Various modifications to these exemplary embodiments presented throughout this disclosure will be readily apparent to those skilled in the art, and the concepts disclosed herein may be applied to apparatus for bridging with 3-D printed components. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus, comprising:
a node having a first portion configured to support a metal sheet and a second portion configured to support a component to thereby couple the metal sheet to the component.

2. The apparatus of claim 1, further comprising the metal sheet supported by the first portion of the node and the component supported by the second portion of the node.

3. The apparatus of claim 2, wherein the component comprises a metal component.

4. The apparatus of claim 2, wherein the component comprises an additively manufactured component.

5. The apparatus of claim 2, wherein the component comprises a panel.

6. The apparatus of claim 1, wherein the first portion of the node comprises a first socket and the second portion of the node comprises a second socket.

7. The apparatus of claim 6, wherein the first socket is located at one end of the node and the second socket is located at an opposite end of the node.

8. The apparatus of claim 6, wherein the node is elongated between the one end of the node and the opposite end of the node.

9. The apparatus of claim 6, wherein the node further comprises an opening located between the first socket and the second socket.

10. The apparatus of claim 1, wherein the node comprises a first section including the first portion and a second section including the second portion, wherein the first section is interconnected with the second section.

11. The apparatus of claim 10, wherein one of the first and second sections comprises a plurality of dovetail structures and the other one of the first and second sections comprises a plurality of sockets with each of the dovetail structures located in a corresponding one of the sockets.

12. The apparatus of claim 11, wherein the first section is co-printed with the second section.

13. The apparatus of claim 11, wherein the first section is joined to the second section.

14. The apparatus of claim 13, wherein the first section is joined to the second section by welding.

15. The apparatus of claim 10, further comprising the metal sheet welded to the first portion of the first section of the node.

16. The apparatus of claim 1, wherein the node further comprises a socket having a plurality of protrusions.

17. The apparatus of claim 16, further comprising the metal sheet located in the socket, the metal having a plurality of holes with each of the protrusions extending through a corresponding one of the holes.

18. The apparatus of claim 16, wherein at least one of the protrusions is stitch welded to an internal surface of the socket.

19. The apparatus of claim 1, the first portion of the node further comprising a first weld protrusion and a second weld protrusion.

20. The apparatus of claim 19, wherein further comprising the metal sheet welded to the node at the first and second weld protrusions.

21. The apparatus of claim 1, wherein the first portion of the node comprises one or more additively manufactured fasteners co-printed with the node.

22. The apparatus of claim 21, wherein each of the one or more fasteners comprises a blind rivet.

23. The apparatus of claim 1, wherein the first portion of the node comprises a slot having a corrugated surface and a flat surface opposite the corrugated surface.

24. The apparatus of claim 23, further comprising an adhesive injection channel for injecting adhesive into the slot.

25. The apparatus of claim 1, wherein the node comprises at least one of an additively manufactured node or an extruded node.

26. The apparatus of claim 1, further comprising at least one of a spacer, a seal, an insert, a gasket, a washer, a lining, a liner, or a sealant between at least one of the first portion and the metal sheet or the second portion and the component, wherein the at least one of a spacer, a seal, an insert, a gasket, a washer, a lining, a liner, or a sealant reduces galvanic corrosion by forming a gap between the at least one of the first portion and the metal sheet or the second portion and the component.

27. A method, comprising:
manufacturing a node having a first portion configured to support a metal sheet and a second portion configured to support a component to thereby couple the metal sheet to the component.

28. The method of claim 27, further comprising:
manufacturing the component supported by the second portion of the node; and
coupling the component to the node.

29. The method of claim 28, wherein the component comprising a metal component.

30. The method of claim 28, wherein manufacturing the component comprises additively manufacturing the component.

31. The method of claim 28, wherein the component comprises a panel.

32. The method of claim 27, wherein additively manufacturing the first portion comprises additively manufacturing a first socket and additively manufacturing the second portion of the node comprises additively manufacturing a second socket.

33. The method of claim 32, wherein additively manufacturing the node comprises additively manufacturing the first socket located at one end of the node and the second socket located at an opposite end of the node.

34. The method of claim 32, wherein additively manufacturing the node comprises additively manufacturing the node with an elongation between the one end of the node and the opposite end of the node.

35. The method of claim 32, wherein additively manufacturing the node further comprises additively manufacturing an opening located between the first socket and the second socket.

36. The method of claim 27, wherein additively manufacturing the node comprises additively manufacturing a first section including the first portion and a second section including the second portion, wherein the first section is interconnected with the second section.

37. The method of claim 36, wherein additively manufacturing one of the first and second sections comprises additively manufacturing a plurality of dovetail structures and wherein additively manufacturing the other one of the first and second sections comprises additively manufacturing a plurality of sockets with each of the dovetail structures located in a corresponding one of the sockets.

38. The method of claim 37, wherein additively manufacturing the first section and the second section comprises co-printed the first section and the second section.

39. The method of claim 37, further comprising joining the first section to the second section.

40. The method of claim 37, wherein joining the first section to the second section comprises welding.

41. The method of claim 36, further comprising welding the metal sheet to the first portion of the first section of the node.

42. The method of claim 27, wherein additively manufacturing the node comprises additively manufacturing the node with a socket having a plurality of protrusions.

43. The method of claim 42, further comprising locating the metal sheet in the socket, the metal having a plurality of holes with each of the protrusions extending through a corresponding one of the holes.

44. The method of claim 42, further comprising stitch welded at least one of the protrusions to an internal surface of the socket.

45. The method of claim 27, wherein additively manufacturing the node further comprises additively manufacturing the first portion of the node including a first weld protrusion and a second weld protrusion.

46. The method of claim 45, further comprising welding the metal sheet to the node at the first and second weld protrusions.

47. The method of claim 27, wherein additively manufacturing the node further comprises additively manufacturing the first portion of the node with one or more additively manufactured fasteners co-printed with the node.

48. The method of claim 47, wherein each of the one or more fasteners comprises a blind rivet.

49. The method of claim 27, wherein additively manufacturing the node further comprises additively manufacturing the first portion of the node with a slot having a corrugated surface and a flat surface opposite the corrugated surface.

50. The method of claim 49, further comprising injecting adhesive into the slot.

51. The method of claim 27, wherein manufacturing the node comprises at least one of additively manufacturing the node or extruding the node.

52. The method of claim 27, wherein manufacturing the node further comprises including at least one of a spacer, a seal, an insert, a gasket, a washer, a lining, a liner, or a sealant between at least one of the first portion and the metal sheet or the second portion and the component, the at least one of a spacer, a seal, an insert, a gasket, a washer, a lining, a liner, or a sealant reducing galvanic corrosion by forming a gap between the at least one of the first portion and the metal sheet or the second portion and the component.
